(19) United States
(12) Patent Application Publication
(10) Pub. No.: US 2003/0182811 A1
(43) Pub. Date: Oct. 2, 2003

(54) Measuring tape radius marking tool

(76) Inventor: Haroutun Hairapetian, Chatsworth, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/107,610

(22) Filed: Mar. 27, 2002

(51) Int. Cl. B43L 9/04

(52) U.S. Cl. 33/27.032

(57) ABSTRACT

A measuring tape radius marking tool includes a block having an open-faced slot. A cut-out is formed in the block generally opposite the slot for holding non-circular markers. An aperture is formed through the block between the slot and the cut-out so as to be aligned with the cut-out for receiving generally circular markers. A portion of a measuring tape corresponding to the distance to be measured from a center point to form a radius marking is disposed within the slot and secured in place. A marker is inserted into either the cut-out or aperture, secured in place, and the tool is moved in an arc to create the measured radius marking.

### BACKGROUND OF THE INVENTION

The present invention generally relates to instruments and tools used in creating arcs or circles. More particularly, the present invention relates to a tool which is attached to a measuring tape for marking radius, arcs, and circles.

Draftsmen, carpenters, cabinet manufacturers, pipe fitters, steel fabricators, etc. often need to mark radiuses or circles for later cutting, welding, etc. Such workers often rely on arc formed devices to draw circles, arcs and intersecting arcs for developing such patterns, cut-outs and the like. Many of these devices are complicated, cumbersome to operate and unhandy to carry about when not in use. Also, there are many instances in which it is necessary to draw a circle or an arc of a circle with the radius larger than that normally allowed by a standard compass or divider. In the past, such workers have drawn the radius using nails, wires, strings or a long stick to find point A to point B of the large radius. This process was time consuming, difficult, and not always accurate.

As such arcing patterns and circles often need to be measured a distance from a designated point, the workers have access to measuring tape, typically in the form of a tape measure. A number of prior inventions include fixtures and attachments to be used with retractable tape measures to draw circles and arcs. However, these devices are not widely available because of manufacturing difficulties and the manner in which the devices operate.

Accordingly, there is a need for a radius marking tool that can be easily attached to a measuring tape and mark circles and arcs of varying lengths from a center point. Such a tool should be intuitive in use, fairly small so as to be transported easily, and inexpensive to manufacture. The present invention fulfills these needs and provides other related advantages.

### SUMMARY OF THE INVENTION

The present invention resides in a measuring tape radius marking tool that can be attached to a measuring tape and used to create radius arcs or circles of varying distances from a given point. The tool generally comprises a block having an open-faced slot. Means, such as a set screw extendable onto the slot, is provided for securing a portion of the measuring tape within the slot. A marker-receiving cut-out is formed in the block generally opposite the slot. Also, a marker-receiving aperture extends through the block between the slot and the cut-out, so as to be aligned with the cut-out.

Means for securing a marker in either the cut-out or the aperture is provided, such as a set screw extendable into either the cut-out or the aperture. The cut-out is generally C-shaped in configuration to receive non-circular markers. Typically, the aperture is cylindrical so as to receive generally cylindrical markers.

An index is associated with the slot and aligned with the aperture and the cut-out. In a particularly preferred embodiment, the index comprises a notch centrally formed on the block and associated with the slot so as to be alignable with markings on the measuring tape disposed within the slot.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a tool embodying the present invention attached to a measuring tape and having a marking instrument secured in an aperture thereof;

FIG. 2 is a perspective view of the tool of FIG. 1, having a noncircular marking instrument secured in a cut-out thereof;

FIG. 3 is an enlarged fragmented perspective view of area “3” of FIG. 2, illustrating a head of a nail inserted into a slot of the measuring tape's end tab;

FIG. 4 is a schematic view of the tool used in association with the measuring tape to create an arc;

FIG. 5 is a schematic view of the use of the tool embodying the present invention to create a circle;

FIG. 6 is a perspective view of the tool embodying the present invention;

FIG. 7 is a top view of the tool of FIG. 6;

FIG. 8 is a bottom plan view of the tool of FIG. 6;

FIG. 9 is a first side view of the tool of FIG. 6;

FIG. 10 is a side view taken generally opposite that of FIG. 9;

FIG. 11 is an end view of the tool of FIG. 6;

FIG. 12 is an end view of the tool taken generally opposite of FIG. 11;

FIG. 13 is a cross-sectional view taken generally along line 13-13 of FIG. 6;

FIG. 14 is a cross-sectional view similar to that of FIG. 13, and illustrating a set screw securing a marker, in phantom, within an aperture of the tool;

FIG. 15 is a cross-sectional view similar to FIG. 13, illustrating a set screw securing a marker, in phantom, within a cut-out of the tool;

FIG. 16 is a cross-sectional view taken generally along line 16-16 of FIG. 8, and illustrating a non-circular marker secured within the cut-out and a measuring tape, in phantom, in the slot;

FIG. 17 is a cross-sectional view taken generally along line 17-17 of FIG. 8, and illustrating a circular marker, in phantom, secured within an aperture thereof; and

FIG. 18 is a partial cross-sectional view taken along line 18-18 of FIG. 6, and illustrating a set screw used in securing a portion of a measuring tape within a slot of the tool.

### DETAILED DESCRIPTION OF THE PREFERRED EMBODIMENTS

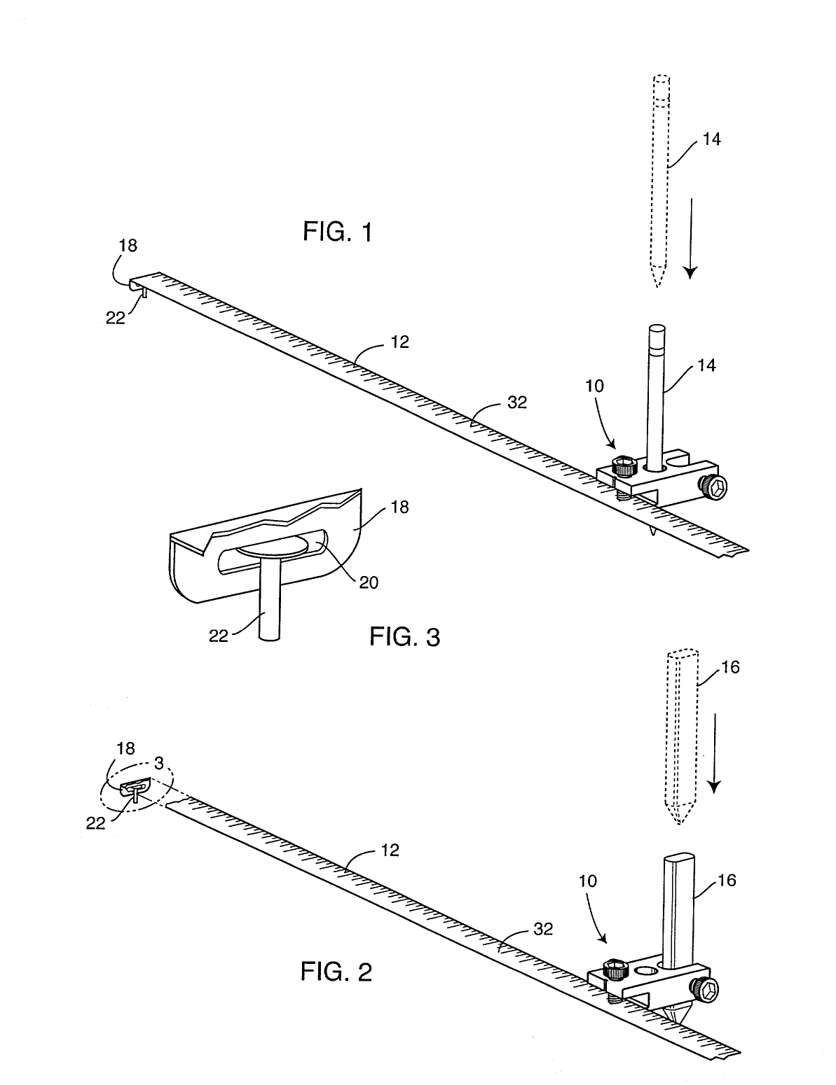

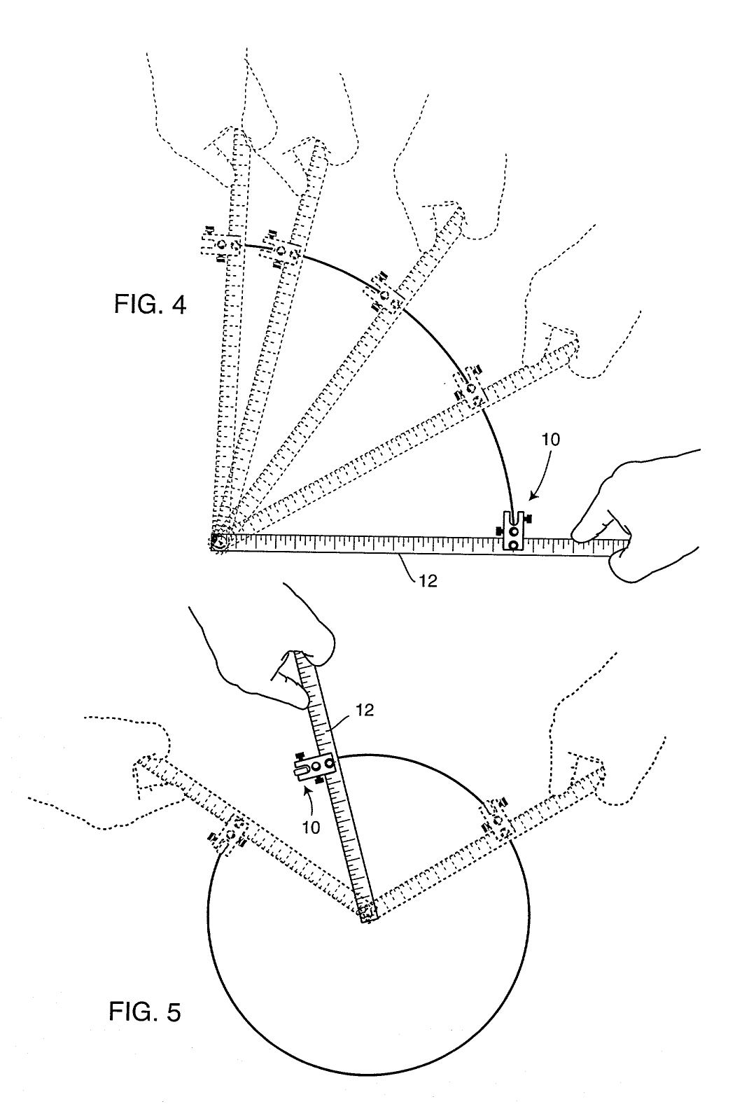

As shown in the accompanying drawings for purposes of illustration, the present is concerned with a measuring tape radius marking tool, generally referred to by the reference number 10 which is attachable to a measuring tape 12 and which accepts either generally circular markers 14, or non-circular markers 16, as shown in FIGS. 1 and 2. The end of the measuring tape 12 is attached to a center point. Typically, as illustrated in FIG. 3, a tab 18 of the measuring tape 12 includes a slot 20 which accepts the head of a nail 22. As illustrated in FIGS. 4 and 5, once the measuring tape 12 is attached to the center point, the measuring tape 12 is rotated to create the desired radius arc marking, or circular marking.

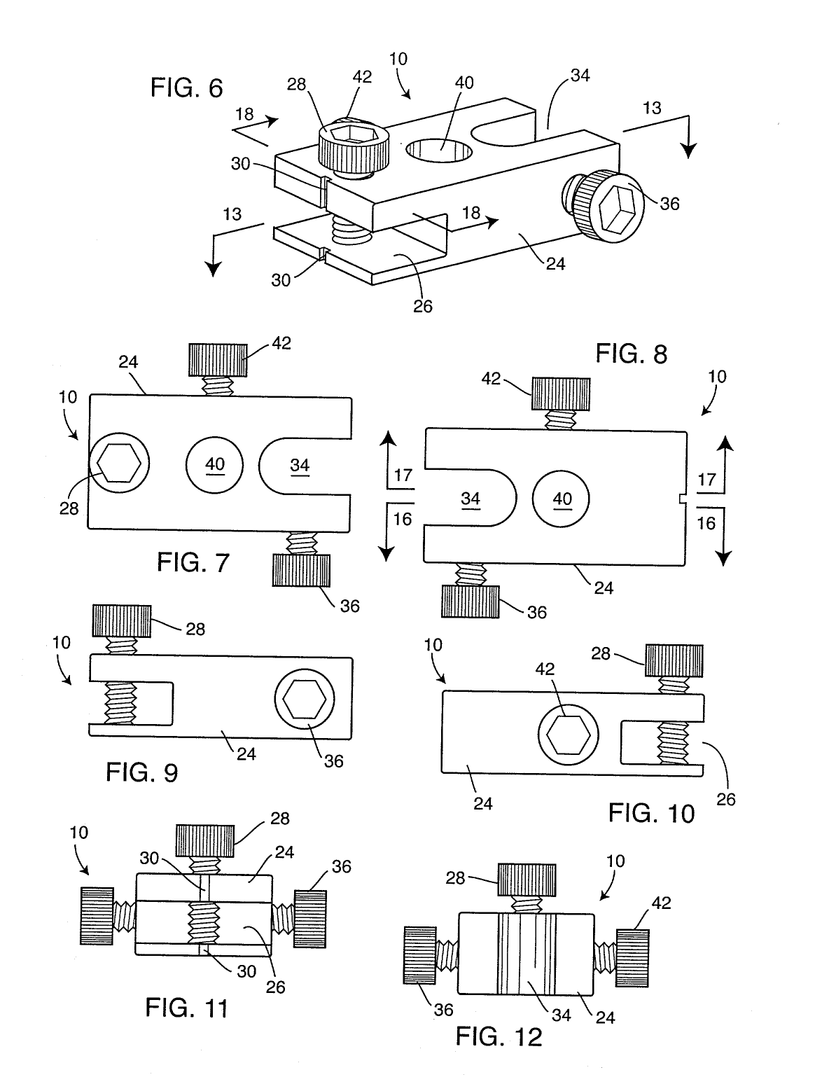

With reference now to FIG. 6, the tool 10 includes a block 24, comprised of a rigid and preferably durable material such as metal. The block 24 includes an open-faced slot 28 formed in one end thereof and configured to receive a portion of the measuring tape 12. Although not limited to such dimensions, the block is typically rectangular and has a width of approximately 0.75 inches, and a length of approximately 1.375 inches. In such a preferred embodiment, the slot 28 is approximately 0.125 inches in height and extends completely through the end of the block 24, as illustrated.

Means are provided for securing the measuring tape 12 within the slot 28. In a particularly preferred embodiment, such means comprises a set screw 28 which is threadably received within an internally threaded aperture 30, as illustrated in FIGS. 16-18, so as to be manually extended into and out of the slot 26. The set screw 28 is of such a length so as to extend fully into the slot 26 and hold even a thin measuring tape 12, as illustrated in FIG. 16, in place within the slot 26.

An index, such as the illustrated notches 30, are associated with the slot 26 at the end of the block 24 so that markings 32 of the measuring tape 12 can be aligned therewith as will be more fully described herein. Although other indexes, such as printed dot or dash markings could be utilized, the illustrated notches 30 are preferred as such will not easily become removed over time with the use of the tool 10.

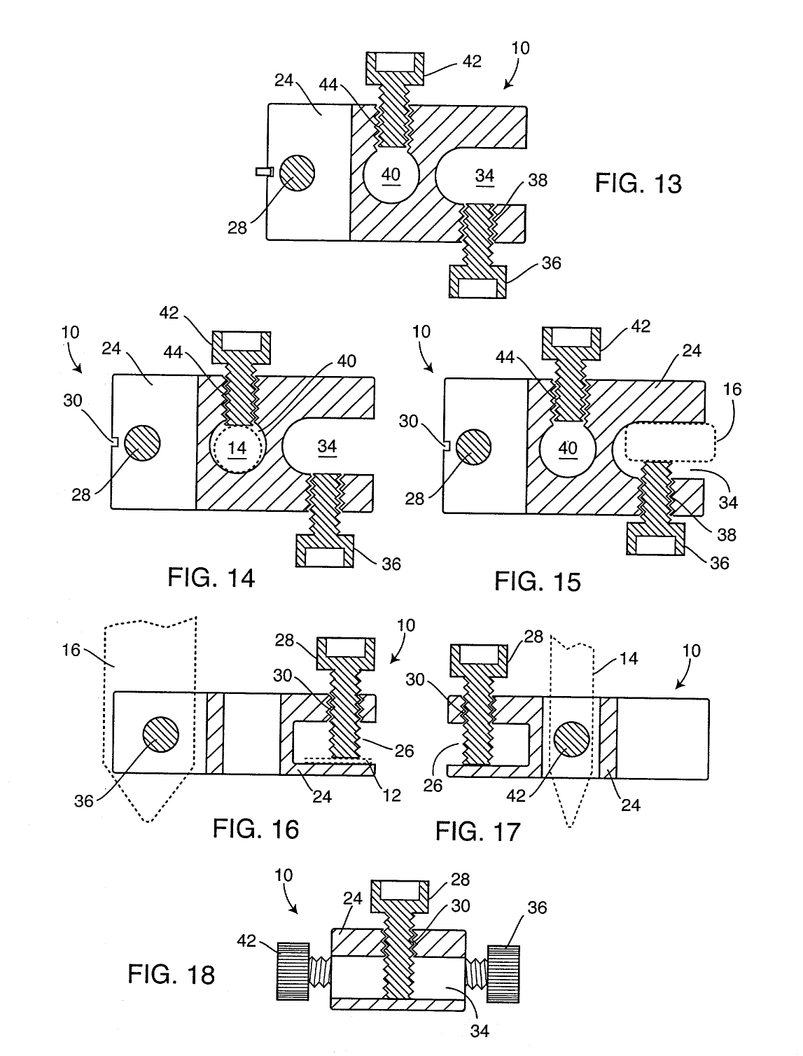

With reference to FIGS. 6-8 and 13-16, a cut-out 34 is formed in the block 24 generally opposite the slot 26. The cut-out 34 is generally C-shaped to accept irregular and non-circular markers 16, such as the square carpenter's pencil illustrated in FIG. 2. Given the illustrated dimensions described above, in the particularly preferred embodiment, the cut-out 34 is approximately 0.50 inches in depth within the block 24, and approximately 0.3125 inches in width to accept such square carpenter's pencil 16. Securing means, such as the illustrated set screw 36 which extends into the cut-out 34 through threaded aperture 38, is used to secure the non-circular marker 16 within the cut-out 34, as illustrated in FIGS. 15 and 16. Thus, the exact dimensions of the cut-out 34 can be varied as the set screw 36 can hold markers 16 of varying dimensions with the cut-out 34. The cut-out 34 is formed in the block 24 such that its primary longitudinal axis is generally aligned with the index notches 30. This allows the secured marker 16 to be generally aligned with the notches 30 so that the resulting radius marking can be accurately measured from the center point, such as the illustrated nail 22 in FIG. 3.

With reference now to FIGS. 6-8, and 13-15, a generally cylindrical aperture 40 is formed through the block 24 between the slot 26 and cut-out 34 so as to be aligned with the cut-out 34 and notches 30. In a particularly preferred embodiment, the aperture 40 is approximately 0.3125 inches in diameter. The aperture 40 is configured to receive generally cylindrical markers, such as the pencil 14 illustrated in FIG. 1. It should be understood that the aperture 40 can also receive multi-faceted markers, such as an octagonal pencil or pen marker having a generally cylindrical shape. Means are provided for securing the marker 14 within the aperture 40. In the illustrated preferred embodiment, such means comprise a manual set screw 42 which is threadably received within threaded aperture 44 and extendable into and out of the aperture 40 so as to secure the marker 14 therein, as illustrated in FIG. 14.

It will be noted that in the accompanying drawings the set screws 28, 36 and 42 all include a knurled outer surface to facilitate the twisting thereof by the thumb and forefinger of the user. It will also be noted that the set screws 28, 36 and 42 include a hexagonal recess for the insertion of Allen wrenches or the like if such are necessary.

With reference again to FIGS. 1-5, in use, a nail 22 is inserted at a center point of the radius. The tabbed end 18 of the measuring tape 12 is hooked onto the head of the nail, using the slot 20, and the measuring tape 12 is extended to the desired length. Of course, it will be appreciated by the reader that the Measuring tape 12 can be of any type, although in such construction and drafting settings the measuring tape 12 typically is extended from a tape measure (not shown). The measuring tape 12 is slid into the slot 26 of the tool 10 such that the desired length marking 32 is aligned with the notches 30. Set screw 28 is then extended into the slot 26 until the measuring tape 12 is secured within the slot 26.

A marker 14 or 16 is inserted into either the circular aperture 40 or C-shaped cut-out 34 and secured therein using thumb screw 36 or 42.

As shown in FIGS. 4 and 5, the user grasps the measuring tape 12, typically the housing of the tape measure, and rotates the measuring tape 12 about the nail 22 to create the arc or circular marking using the marker 14 or 16. As will be appreciated by those skilled in the art, multiple arc or circular drawings can be made from the same center point by loosening thumb screw 28 and moving tool 10 along the length of the measuring tape 12. In fact, radius drawings may be easily made along any length of the measuring tape 12. Thus, it is conceivable that a radius marking could be made one hundred feet from the center point using a one hundred foot measuring tape 12. Also, a radius drawing or circle could be made a mere few inches from the center point using the same measuring tape 12.

Aside from the benefits described above, the tool 10 of the present invention is very intuitive in use, accommodates various marking instruments and measuring tape sizes, and is small enough to easily transport in a construction worker's pocket or tool chest.

Although several embodiments have been described in detail for purposes of illustration, various modifications may be made without departing from the scope and spirit of the invention. Accordingly, the invention is not to be limited, except as by the appended claims.

What is claimed is:

1. A measuring tape radius marking tool, comprising:
a block having an open-faced slot;
means for securing a portion of a measuring tape within the slot;
a marker-receiving cutout formed in the block generally opposite the slot; and
a marker-receiving aperture through the block between the slot and the cutout and aligned with the cutout.

2. The tool of claim 1, wherein the measuring tape securing means comprises a set screw extendible into the slot.

3. The tool of claim 1, wherein the cutout is generally C-shaped in configuration to receive non-circular markers.

4. The tool of claim 1, including means for securing a non-circular marker within the cutout.

5. The tool of claim 4, wherein the marker securing means comprises a set screw extendible into the cutout.

6. The tool of claim 1, including means for securing a circular marker within the aperture.

7. The tool of claim 6, wherein the marker securing means comprises a set screw extendible into the aperture.

8. The tool of claim 1, including an index associated with the slot and aligned with the aperture and the cutout.

9. The tool of claim 8, wherein the index comprises a notch centrally formed on the block and alignable with markings on the measuring tape disposed within the slot.

10. A measuring tape radius marking tool, comprising:
a block having an open-faced slot;
means for securing a portion of a measuring tape within the slot;
a marker-receiving cutout formed in the block generally opposite the slot;
means for securing a marker within the cutout;
a marker-receiving aperture through the block between the slot and the cutout and aligned with the cutout;
means for securing a marker within the aperture; and
an index associated with the slot and aligned with the aperture and cutout and alignable with markings on the measuring tape disposed within the slot.

11. The tool of claim 10, wherein the measuring tape securing means comprises a set screw extendible into the slot.

12. The tool of claim 10, wherein the cutout is generally C-shaped in configuration to receive non-circular markers.

13. The tool of claim 10, wherein the marker securing means comprises a set screw extendible into the cutout.

14. The tool of claim 10, wherein the marker securing means comprises a set screw extendible into the aperture.

15. The tool of claim 10, wherein the index comprises a notch centrally formed on the block and alignable with markings on the measuring tape disposed within the slot.

16. The tool of claim 10, wherein the aperture is cylindrical.

17. A measuring tape radius marking tool, comprising:
a block having an open-faced slot;
a set screw extendible into the slot for securing a portion of a measuring tape within the slot;
a generally C-shaped marker-receiving cutout formed in the block generally opposite the slot;
a set screw extendible into the cutout for securing a non-circular marker within the cutout;
a cylindrical marker-receiving aperture through the block between the slot and the cutout and aligned with the cutout;
a set screw extendible into the aperture for securing a marker within the aperture; and
an index comprising a notch formed on the block in association with the slot and aligned with the aperture and cutout and alignable with markings on the measuring tape disposed within the slot.
